(19) United States
(12) Patent Application Publication
(10) Pub. No.: US 2023/0171566 A1
(43) Pub. Date: Jun. 1, 2023

(54) MULTICAST BROADCAST SERVICE RECEPTION WITH DUPLICATED DATA PACKETS

(71) Applicant: MediaTek Singapore Pte. Ltd., Singapore (SG)

(72) Inventors: Xuelong Wang, Beijing (CN); Yuanyuan Zhang, Beijing (CN)

(21) Appl. No.: 18/154,002

(22) Filed: Jan. 12, 2023

Related U.S. Application Data
(63) Continuation of application No. PCT/CN2021/106413, filed on Jul. 15, 2021.
Application No. PCT/CN2021/106413 is a continuation of application No. PCT/CN20/03241, filed on Jul. 21, 2020.

(30) Foreign Application Priority Data
Jul. 21, 2020 (CN) PCT/CN2020/103241
Jul. 15, 2021 (CN) PCT/CN2021/106413

(51) Int. Cl. H04W 4/06; H04L 1/1867; H04L 1/1607; H04W 76/40

(52) U.S. Cl. CPC H04W 4/06; H04L 1/189; H04L 1/1642; H04W 76/40

(57) ABSTRACT

Apparatus and methods are provided for MBS reception with duplicate data packets. In one novel aspect, the UE establishes a protocol stack with a PTM leg and a PTP leg, receives duplicated data packets from both the PTM leg and the PTP leg, and processes the duplicated data packets from the PTM and the PTP legs at a duplication protocol layer. The MBS data packets are duplicated at corresponding duplication protocol layer at the network node. The UE duplication protocol layer is either the PDCP layer, or the RLC layer, or the PHY layer. The RLC layer includes a PTM RLC entity and a PTP RLC entity when the RLC SN are different in the PTM. The UE duplication protocol layer combines received data packets and/or discards duplicated data packets from the PTM leg and the PTP leg.

### CROSS REFERENCE TO RELATED APPLICATIONS

This application is filed under 35 U.S.C. § 111(a) and is based on and hereby claims priority under 35 U.S.C. § 120 and §365(c) from International Application No. PCT/CN2021/106413, titled “Multicast Broadcast Service Reception with Duplicated Data Packets,” filed on Jul. 15, 2021. International Application PCT/CN2021/106413, in turn, is filed under 35 U.S.C. § 111(a) and is based on and hereby claims priority under 35 U.S.C. § 120 and § 365(c) from International Application No. PCT/CN2020/103241, titled “Methods and apparatus of Multicast and Broadcast Service Reception,” with an international filing date of Jul. 21, 2020. The disclosure of each of the foregoing documents is incorporated herein by reference.

### TECHNICAL FIELD

The disclosed embodiments relate generally to wireless communication, and, more particularly, to multicast broadcast service reception with duplicated data packets.

### BACKGROUND

With the exponential growth of wireless data services, the content delivery to large mobile user groups has grown rapidly. Initial wireless multicast/broadcast services include streaming services such as mobile TV and IPTV. With the growing demand for large group content delivery, recent application development for mobile multicast services requires highly robust and critical communication services such as group communication in disaster situations and the necessity of public safety network-related multicast services. The early 3GPP in the LTE standard defines enhanced multimedia broadcast multicast services eMBMS. The single-cell point to multipoint (SC-PTM) services and multicast-broadcast single-frequency network (MBSFN) is defined. The fifth generation (5G) multicast broadcast services (MBS) are defined based on the unicast 5G core (5GC) architecture. A variety of applications may rely on communication over multicast transmission, such as live stream, video distribution, vehicle-to-everything (V2X) communication, public safety (PS) communication, file download, and so on. In some cases, there may be a need for the cellular system to enable reliable multicast/broadcast transmission to ensure the reception quality at the UE side. Reception and transmission for MBS in the NR system require higher reliability. To ensure higher reliability, feedback on the reception of the MBS data packets, which helps the network to perform necessary retransmission, is needed. Further, the traditional way of transmission and reception on a single point-to-multipoint (PTM)/multicast radio bearer (RB) does not meet the requirements of MBS reliabilities for many services.

Improvements and enhancements are required to support MBS transmission and reception to enhance reliability.

### SUMMARY

Apparatus and methods are provided for reliable multicast broadcast services (MBS) reception with duplicate data packets. In one novel aspect, the UE establishes a protocol stack for a configured MBS with a PTM leg and a PTP leg, receives duplicated data packets from the MBS simultaneously from both the PTM leg and the PTP leg. The UE processes the duplicated data packets from the PTM and the PTP legs at a duplication protocol layer, wherein data packets for the MBS are duplicated at corresponding duplication protocol layer at the network node. In one embodiment, the UE duplication protocol layer is the PDCP layer and the PDCP SN are unified at the PTM leg and the PTP leg. In another embodiment, the UE duplication protocol layer is the RLC layer. The RLC layer includes two RLC entities, one for the PTM leg and one for the PTP leg when the RLC SN are different in the PTM and the PTP legs. In another embodiment, the RLC layer includes one RLC entity when the RLC SN from the PTM leg and the PTP leg are aligned. In yet another embodiment, the UE duplication layer is the PHY layer and wherein the PTM leg and the PTP leg are both received from the perspective of hybrid automatic repeat request (HARQ). The UE monitors a G-RNTI for the PTM leg and a C-RNTI for the PTP leg. The UE duplication protocol layer combines received data packets from the PTM leg and the PTP leg and/or discards duplicated data packets from the PTM leg and the PTP leg.

In another novel aspect, the base station establishes a network protocol stack for DL data packets of a configured MBS with a PTM leg and one or more PTP legs for one or more subscriber UEs. The base station transmits duplicated data packets for the MBS simultaneously from both the PTM leg and the PTP leg, wherein data packets for the MBS are duplicated at a duplication protocol layer. In one embodiment, the duplication layer is either a PHY with HARQ, a RLC layer, or a PDCP layer.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary NR wireless network that supports MBS transmission and reception with duplicated data packets in a wireless network.

FIG. 2 illustrates an exemplary NR wireless system with centralized upper layers of the NR radio interface stacks and UE stack with multicast protocol and unicast protocol.

FIG. 3 illustrates exemplary diagrams for different delivery modes with the PTM leg and the PTP leg for MBS data packets transmission and reception.

FIG. 4 illustrates exemplary diagrams for duplicated HARQ reception over the PTM and PTP legs.

FIG. 5 illustrates exemplary diagrams for duplicated RLC reception over the PTM and PTP legs.

FIG. 6 illustrates exemplary diagrams for duplicated PDCP reception over the PTM and PTP legs.

FIG. 7 illustrates exemplary diagrams of top-level procedures for different MBS mode switch procedures in MBS transmission and reception.

FIG. 8 illustrates an exemplary flow chart for the UE MBS reception with duplicated data packets.

FIG. 9 illustrates an exemplary flow chart for the base station MBS transmission with duplicated data packets.

### DETAILED DESCRIPTION

Reference will now be made in detail to some embodiments of the invention, examples of which are illustrated in the accompanying drawings.

Aspects of the present disclosure provide methods, apparatus, processing systems, and computer readable mediums for NR (new radio access technology, or 5G technology) or other radio access technology. NR may support various wireless communication services, such as enhanced mobile broadband targeting wide bandwidth, millimeter wave targeting high carrier frequency, massive machine type communications targeting non-backward compatible MTC techniques, and/or mission critical targeting ultra-reliable low-latency communications. These services may include latency and reliability requirements. These services may also have different transmission time intervals (TTI) to meet respective quality of service (QoS) requirements. In addition, these services may co-exist in the same subframe.

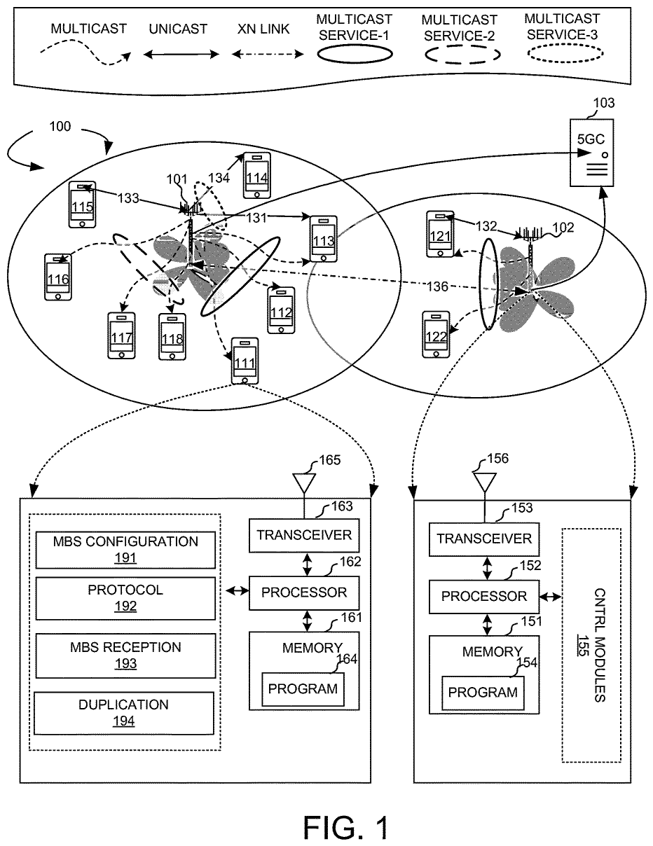

FIG. 1 is a schematic system diagram illustrating an exemplary NR wireless network that supports MBS transmission and reception with duplicated data packets in a wireless network. A wireless system 100, such as a NR system, includes one or more fixed base infrastructure units forming a network distributed over a geographical region. The base unit may also be referred to as an access point, an access terminal, a base station, a Node-B, an eNode-B (eNB), a gNB, or by other terminology used in the art. The network can be homogeneous network or heterogeneous network, which can be deployed with the same frequency or different frequency. gNB 101 and gNB 102 are base stations in the NR network, the serving area of which may or may not overlap with each other. The backhaul connection such as 136, connects the non-co-located receiving base units, such as gNB 101 and gNB 102. These backhaul connections, such as connection 136, can be either ideal or non-ideal. gNB 101 connects with gNB 102 via Xnr interface. The base stations, such as gNB 101 and gNB 102, connects to the 5G core (5GC) network 103 through network interfaces, such as N2 interface for the control plane and N3 interface for the user plane.

NR wireless network 100 also includes multiple communication devices or mobile stations, such as user equipments (UEs) 111, 112, 113, 114, 116, 117, 118, 121 and 122. The UE may also be referred to as mobile station, a mobile terminal, a mobile phone, smart phone, wearable, an IoT device, a table let, a laptop, or other terminology used in the art. The mobile devices can establish one or more unicast connections with one or more base stations. For example, UE 115 has unicast connection 133 with gNB 101. Similarly, UEs 121 connects with gNB 102 with unicast connection 132.

In one novel aspect, one or more radio bearers are established for one or more multicast sessions/services and the UE provides uplink feedback. A multicast service-1 is provided by gNB 101 and gNB 102. UEs 111, 112 and 113 receive multicast services from gNB 101. UEs 121 and 122 receive multicast services from gNB 102. Multicast service-2 is provided by gNB 101 to the UE group of UEs 116, 117, and 118. Multicast service-1 and multicast service-2 are delivered in multicast mode with a multicast radio bearer (MRB) configured by the NR wireless network. The receiving UEs receives data packets of the multicast service through corresponding MRB configured. UE 111 receives multicast service-1 from gNB 101. gNB 102 provides multicast service-1 as well. UE 121 is configured with multicast service-1. UE 121 is configured multicast RB as well as the unicast RB 132. The unicast RB 132 receives MBS data packets together with the multicast RB. The unicast RB 132 is used to provide reliable MBS for UE 121. Similarly, UEs 111, 112, and 113 receive multicast service-1 through corresponding multicast RB and/or the unicast RB. Each UE receiving MBS is also configured with at least one corresponding unicast RB for reliability. Similarly, for multicast service-2, UEs 116, 117, and 118 receive multicast serine-2 through corresponding multicast RB and/or unicast RB. Each UE receiving MBS is also configured with at least one corresponding unicast RB for reliability. In one scenario, multicast services are configured with unicast radio bearers. A multicast service-3 is delivered to UE 113 and UE 114 via unicast radio link 131 and 134, respectively. In one embodiment, the MBS delivered through unicast bearer through PTP protocol stack are switched to PTM leg configured for the UE upon detecting predefined events. The gNB, upon detecting one or more triggering event, switches service mode from unicast to multicast using PTM legs.

FIG. 1 further illustrates simplified block diagrams of a base station and a mobile device/UE for MBS transmission and reception with duplicated data packets. gNB 102 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 102. Memory 151 stores program instructions and data 154 to control the operations of gNB 102. gNB 102 also includes a set of control modules 155 that carry out functional tasks to communicate with mobile stations.

FIG. 1 also includes simplified block diagrams of a UE, such as UE 111. The UE has an antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown). A first RF module is used for High Frequency (HF) transmitting and receiving, and the other RF module is used for different frequency bands transmitting and receiving which is different from the HF transceiver. RF transceiver 163 also converts received baseband signals from processor 162, converts them to RF signals, and sends out to antenna 165. Processor 162 processes the received baseband signals and invokes different functional modules to perform features in UE 111. Memory 161 stores program instructions and data 164 to control the operations of UE 111. Antenna 165 sends uplink transmission and receives downlink transmissions to/from antenna 156 of gNB 102.

The UE also includes a set of control modules that carry out functional tasks. These control modules can be implemented by circuits, software, firmware, or a combination of them. An MBS configuration module 191 configures an MBS with a network node in the wireless network. A protocol module 192 establishes a UE protocol stack for downlink (DL) data packets of the MBS with a point-to-multipoint (PTM) leg and a point-to-point (PTP) leg. An MBS reception module 193 receives duplicated data packets for the MBS simultaneously from both the PTM leg and the PTP leg. A duplication module 194 processes the received duplicated data packets from the PTM leg and the PTP leg at a duplication protocol layer, wherein data packets for the MBS are duplicated at corresponding duplication protocol layer at the network node.

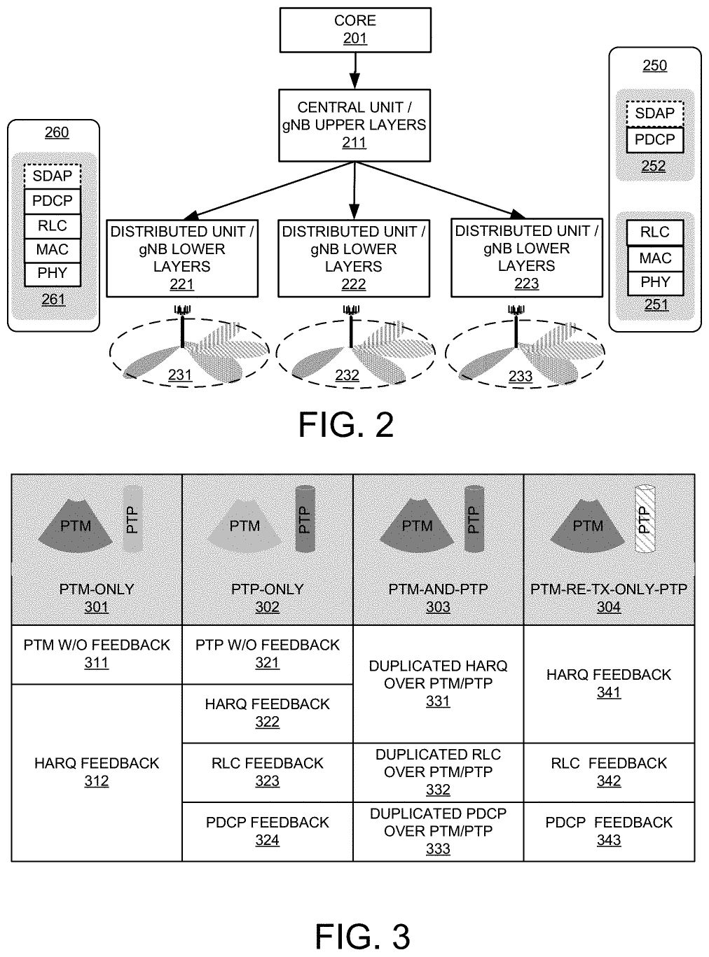

FIG. 2 illustrates an exemplary NR wireless system with centralized upper layers of the NR radio interface stacks and UE stack with multicast protocol and unicast protocol. Different protocol split options between central unit (CU) and distributed unit (DU) of gNB nodes may be possible. The functional split between the CU and DU of gNB nodes may depend on transport layer. Low performance transport between the CU and DU of gNB nodes can enable higher protocol layers of the NR radio stacks to be supported in the CU, since the higher protocol layers have lower performance requirements on the transport layer in terms of bandwidth, delay, synchronization, and jitter. In one embodiment, SDAP and PDCP layers are located in the CU, while RLC, MAC and PHY layers are located in the DU. A core unit 201 is connected with one central unit 211 with gNB upper layer 252. In one embodiment 250, gNB upper layer 252 includes the PDCP layer and optionally the SDAP layer. Central unit 211 connects with distributed units 221, 222, and 221. Distributed units 221, 222, and 223 each corresponds to a cell 231, 232, and 233, respectively. The DUs, such as 221, 222 and 223 includes gNB lower layers 251. In one embodiment, gNB lower layers 251 include the PHY, MAC and the RLC layers. In another embodiment 260, each gNB has the protocol stack 261 including SDAP, PDCP, RLC, MAC and PHY layers.

There are two delivery methods for the transmission of MBS packet flows over radio. Point-to-Multipoint (PTM) delivery method means a radio area network (RAN) node delivers a single copy of MBS data packets over radio to a set of UEs. Point-to-Point (PTP) delivery method means a RAN node delivers separate copies of MBS data packet over radio to individual UE. The RAN node (i.e., gNB or base station) may use PTM, PTP or a combination of PTP/PTM mode to deliver the MBS data of a particular MBS service to the interested UEs within a cell. The support of the simultaneous PTP/PTM delivery method is to cater for the diverse handling for the UEs for the MBS service reception, e.g., different radio resource utilization schemes, or different QoS requirements. In addition, taking account of the requirement to support reliable multicast transmission, a companion/associated PTP delivery leg may be used to perform UE specific retransmissions. Then from the RAN node perspective, there are four delivery modes available to deliver MBS data over the air interface: PTM only transmission, PTP only transmission, PTM and PTP (with PTP for initial transmission) and PTM and PTP (with PTP only for retransmission).

FIG. 3 illustrates exemplary diagrams for different delivery modes with the PTM leg and the PTP leg for MBS data packets transmission and reception. The RAN node/network node configures an MBS for one or more subscriber UEs in the wireless network. Each subscriber UE configures the MBS with the network node. When the RAN node configures both PTM leg and leg for MBS data delivery for a particular MBS session, some UEs may only receive the PTM leg, some UEs may only receive the PTP leg, and some UEs may receive both PTM leg and PTP leg.

From UE reception perspective, corresponding to the delivery modes adopted by the RAN node, there are also different options to model the reception behavior. The four delivery modes comprise a PTM-only mode 301, a PTP-only mode 302, a PTM-and-PTP mode 303, and a PTM-plus-retransmission-only-PTP mode 304. For PTM-only mode 301, the UE only receives the PTM leg regardless of any other PTP legs established by the network for other UEs. From UE perspective, the reliable reception is not expected in this case. This option requires the RAN node to establish a PTM leg for the transmission of a particular MBS session. For PTP-only mode 302, the UE only receives the PTP leg regardless of ongoing PTM legs established for other UEs by the network. From UE perspective, the reliable reception can be expected if required. This option requires the RAN node to establish UE specific PTP leg(s) for the transmission of a particular MBS session. For PTM-and-PTP mode 303, the UE receives the initial transmission of the MBS data from both PTM leg and PTP leg. The RAN node establishes both PTM leg and UE specific PTP leg for the UE. The RAN node delivers the data in a duplicated manner to both PTM leg and UE specific PTP leg. During the MBS reception, the UE combines the received duplicated MBS data packets from the PTM leg and the PTP leg and discards the duplicated data if any. For PTM-plus-retransmission-only-PTP mode 304, the UE receives the initial transmission of the MBS data from the PTM leg. The UE receives the retransmission of MBS data from the PTP leg. The RAN node establishes both PTM leg and UE specific PTP leg for the UE. The PTP leg is only used for data retransmission based on UE specific uplink feedback. During MBS reception, the UE combines the received data from the two legs.

Depending on the protocol layer to handle the uplink feedback, duplicated reception or the reception on the retransmitted data at PTM leg and/or PTP leg, different configurations/alternatives are implemented for each MBS mode.
Alt-1A 311: PTM only reception without provisioning of UL feedback, which is legacy PTM reception.
Alt-1B 312: PTM only reception with HARQ layer uplink feedback.
Alt-2A 321: PTP only reception without provisioning of UL feedback, which is legacy PTP reception.
Alt-2B 322: PTP only reception with HARQ layer uplink feedback, which is legacy PTP reception.
Alt-2C 323: PTP only reception with RLC layer uplink feedback, which is legacy PTP reception.
Alt-2D 324: PTP only reception with PDCP layer uplink feedback, which is legacy PTP reception.
Alt-3B 331: PTM/PTP reception with duplicated HARQ layer reception over PTM/PTP leg.
Alt-3C 332: PTM/PTP reception with duplicated RLC layer reception over PTM/PTP leg.
Alt-3D 333: PTM/PTP reception with duplicated PDCP layer reception over PTM/PTP leg.
Alt-4B 341: PTM/PTP reception with HARQ layer uplink feedback (the reception of the PTP leg is for HARQ retransmission).
Alt-4C 342: PTM/PTP reception with RLC layer uplink feedback (the reception of the PTP leg is for RLC retransmission).
Alt-4D 343: PTM/PTP reception with PDCP layer uplink feedback (the reception of the PTP leg is for PDCP retransmission).

For Alt-1A 311, no feedback is provided from the UE. This configuration applies to services such as broadcast applications. In one embodiment, the network performs one-shot transmission. In another embodiment, the network performs blind retransmission at HARQ or L2. Following the general principle of PTM RB reception, it requires the UE to establish a single PDCP entity and RLC entity for downlink (DL) reception and the RLC entity runs in receiving only mode. For Alt-1B 312, the UE needs to provide the HARQ feedback according to the resource allocated by the RAN node. In one embodiment, the HARQ feedback is used by the network to determine the needed retransmission. For PTP-only mode procedures, including Alt-2A 321, Alt-2B 322, Alt-2C 323, and Alt-2D 324, the UE is configured with a PTP leg for the MBS. The UE receives MBS data packets using unicast reception. The network needs to establish an independent UE specific PTP RB for the UE.

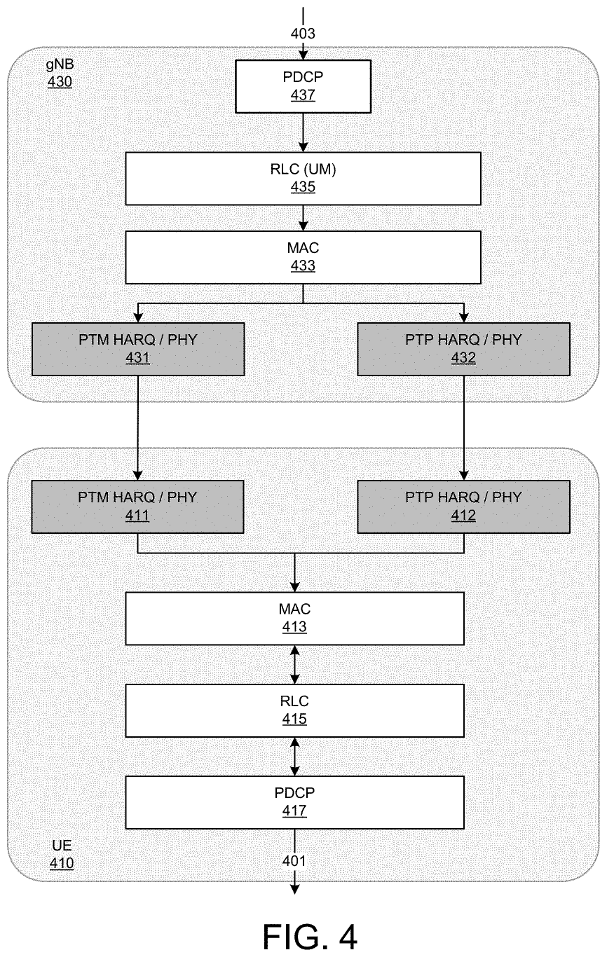

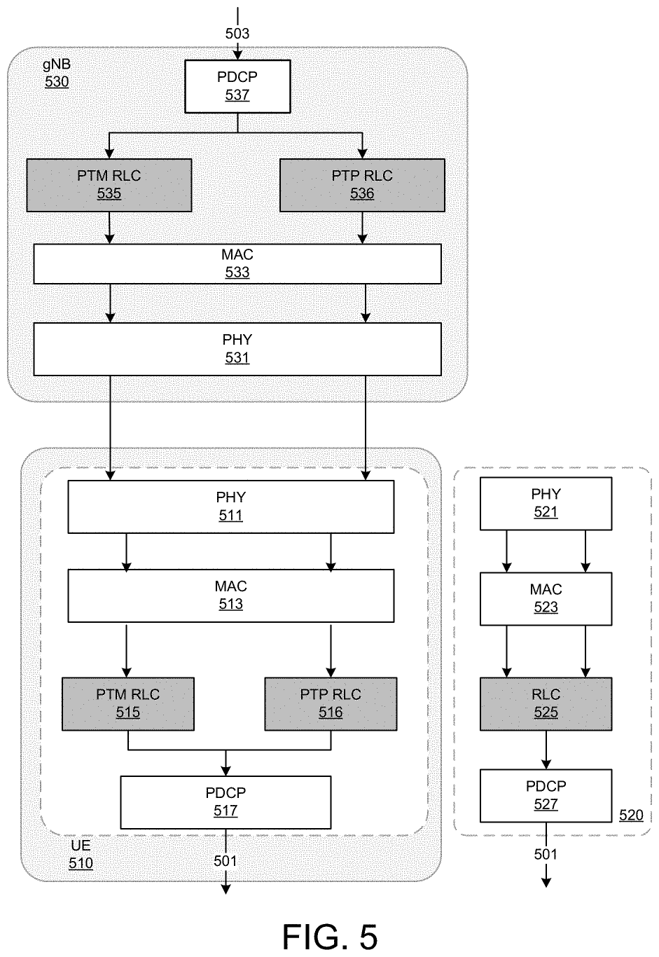

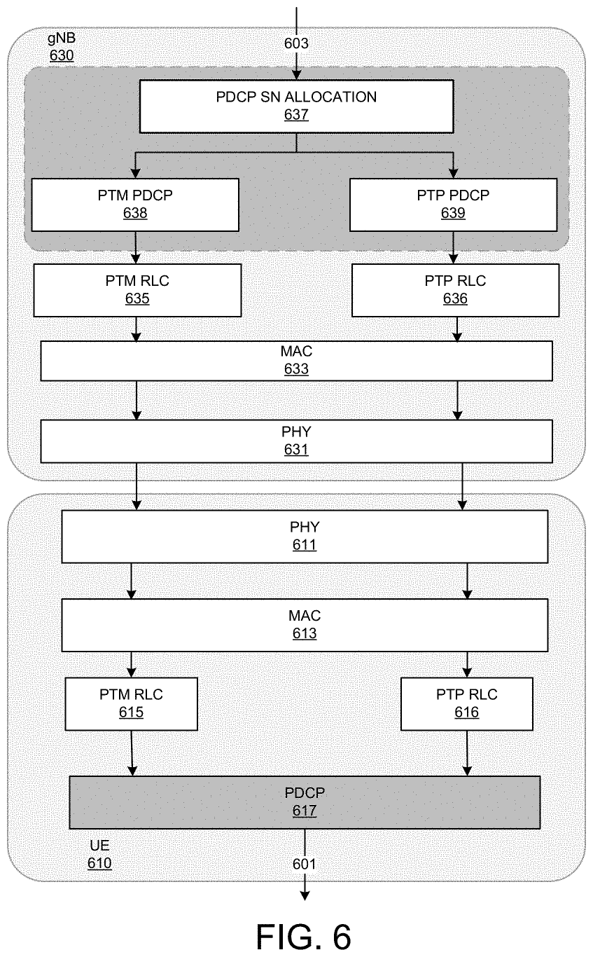

For the PTM-and-PTP mode 303, three alternatives 331, 333, and 334 are available. For Alt-3B 331, the UE receives both PTM leg and PTP leg at HARQ layer. In one embodiment of Alt-3B 331, the duplication is at the PHY layer from the HARQ perspective with details in FIG. 4. In another embodiment Alt-3C 332, the duplication is at the RLC layer with details in FIG. 5. In yet another embodiment of Alt-3D 333, the duplication is at the PDCP layer with details in FIG. 6.

For the PTM-plus-retransmission-only-PTP mode 304, three alternatives 341, 342, and 343 are available. In one embodiment of Alt-4B 341, the UE receives both PTM leg and PTP leg from the perspective of HARQ. In one embodiment, the UE monitors the group radio group RNTI (G-RNTI) scrambled PDCCH for PTM reception and monitors the cell RNTI (C-RNTI) scrambled PDCCH for PTP reception. The UE can only receive the HARQ retransmission of a TB from the PTP leg. The UE always receive different RV versions of the same TB from the two legs. In one embodiment, the HARQ combining is performed at the physical layer. The UE provides its uplink HARQ feedback to the network based on the result of the HARQ combining for a particular TB, with the expectation to receive the HARQ retransmission for the same TB from PTP leg. From RAN node side, the initial transmission of the TB for the multicast data is performed at the PTM leg and the retransmission of the TB takes place at PTP leg. In one embodiment, the HARQ transmission is supported by different HARQ entities or different HARQ processes.

In another embodiment of Alt-4C 342, at UE side, the UE performs the PTP and PTM reception together. Monitoring the PTP leg is only for the purpose of the reception of the retransmitted RLC packets. The UE establishes a single/combined DRB and a single PDCP entity to receive both PTM leg and PTP leg. The UE can establish a single RLC entity to receive the two legs. UE monitors two independent LCHs (one for PTM data and the other for PTP data) via different RNTIs. UE assembles the data packets from two independent LCHs at RLC, since it assumes the SN is aligned, as the SN is supposed to be allocated by a single RLC SN allocation function block at network side. In uplink, UE provides the uplink feedback (i.e., RLC status report) to the network, when there is a Polling Request received for the multicast transmission. There are independent RLC functions supported at the network side for each UE. It should be noted that the PTP RLC functions are only part of RLC entity functions as there is no SN allocation function. The PDCP packets are delivered to a common RLC SN allocation function block at the RLC layer. The PTM RLC entity runs for initial PTM transmission. Any transmission in PTP (or in the unicast manner) is for PTP retransmission. In one embodiment, there are one or more retransmission buffers for each UE specific RLC AM entity.

In yet another embodiment of Alt-4D 343, at UE side, the UE performs the PTP and PTM reception together. The UE establishes a single/combined DRB and a single PDCP entity to receive both the PTM leg and the PTP leg. In one embodiment, the UE establishes two RLC entities to receive the two legs, The two RLC entities both run in RLC UM mode. The UE monitors two independent LCHs (one for PTM data and the other for PTP data) via different RNTIs. The UE assembles the data packets from two independent LCHs at PDCP. The UE assumes the SN is aligned since the SN is supposed to be allocated by a single PDCP SN allocation function block at network side. In uplink, the UE provides the uplink feedback (i.e., PDCP status report) to the network. In one embodiment, the uplink report is sent to the network when a polling request is received for the multicast transmission. From network side, there are independent PDCP functions supported at network side for each UE. The PTP PDCP functions are only part of RLC entity functions as there is no SN allocation function. The SDAP packets are delivered to a common PDCP SN allocation function block at PDCP layer. The PTM PDCP entity runs for initial PTM transmission. Any transmission in PTP (or unicast manner) is for PTP retransmission. In one embodiment, there are one or more retransmission buffers for each UE specific PDCP AM entity.

FIG. 4 illustrates exemplary diagrams for duplicated HARQ reception over the PTM and PTP legs. UE 410 is configured with an MBS. UE 410 is configured with a UE protocol stack for downlink (DL) data packets of the MBS with a PTM leg and a PTP leg. UE 410 protocol stack includes two PHY entities, a PTM HARQ 411 and a PTP HARQ 412. UE 410 protocol stack also includes a MAC entity 413, a RLC entity 415, and a PDCP entity 417. UE 410 receives duplicated data packets for the MBS simultaneously from both the PTM leg and the PTP leg, processes the received duplicated data packets from the PTM leg and the PTP leg at a duplication protocol layer (e.g., PHY layer), wherein data packets for the MBS are duplicated at corresponding duplication protocol layer at the network node. PDCP entity 417 sends the processed data packets 401 to upper layer of UE 410. An exemplary network node, gNB 430, transmits one or more multicast flows 403 for an MBS to one or more UEs, such as UE 410. The MBS from gNB 430 is configured with a PTM RB and a PTP RB. The UE monitors the group radio group RNTI (G-RNTI) scrambled PDCCH for PTM reception and monitors the cell RNTI (C-RNTI) scrambled PDCCH for PTP reception. The UE may receive the same transmission block (TB) from both legs. The UE may receive the same or different RV versions of the same TB from the two legs. The HARQ combining is performed at the physical (PHY) layer with PHY entity 411 and 412. In one embodiment, the UE provides its uplink HARQ feedback to the network based on the result of the HARQ combining for a particular TB, with the expectation of receiving the HARQ retransmission for the same TB. From network node side, the multicast data packets are duplicated over the PTM leg and the PTP leg at the HARQ layer with different HARQ entities or different HARQ processes, such as PTM HARQ at PHY 431 and PTM HARQ at PHY 432. gNB 430 transmits duplicated data packets for the MBS simultaneously from both the PTM leg and the PTP leg, wherein data packets for the MBS are duplicated at a duplication protocol layer, the PHY layer with HARQ entities 431 and 432. The network protocol stack also includes a MAC entity 433, an RLC (UM) entity 435 and a PDCP entity 437.

FIG. 5 illustrates exemplary diagrams for duplicated RLC reception over the PTM and PTP legs. UE 510 is configured with an MBS. UE 510 is configured with a UE protocol stack for downlink (DL) data packets of the MBS with a PTM leg and a PTP leg. UE 510 protocol stack includes a PHY entity 511, a MAC entity 513, two RLC entities, which comprise a PTM RLC entity 515 and a PTP RLC entity 516, and a PDCP entity 517. UE 510 receives duplicated data packets for the MBS simultaneously from both the PTM leg and the PTP leg, processes the received duplicated data packets from the PTM leg and the PTP leg at a duplication protocol layer (e.g., the RLC layer), wherein data packets for the MBS are duplicated at the RLC layer at the network node. PDCP entity 517 sends the processed data packets 501 to upper layer of UE 510.

An exemplary network node, gNB 530, transmits one or more multicast flows 503 for an MBS to one or more UEs, such as UE 510. gNB 530 establishes a network protocol stack for downlink (DL) data packets of the MBS with a point-to-multipoint (PTM) leg and one or more point-to-point (PTP) legs for the one or more subscriber UEs and transmits duplicated data packets for the MBS simultaneously from both the PTM leg and the PTP leg, wherein data packets for the MBS are duplicated at a duplication protocol layer, the RLC layer with RLC entities 535 and 536. The network protocol stack also includes a PHY entity 531, a MAC entity 533 and a PDCP entity 537.

In one embodiment, RLC SNs of the PTM leg is different from RLC SNs of the PTP leg. The UE protocol stack includes two RLC entities, one for the PTM leg 515 and one for the PTP leg 516. A PDCP layer 517 of the UE protocol stack discards duplicated data packets. The UE receives both PTM leg and PTP leg from the perspective of RLC in a single DRB. In one embodiment, the UE receives the same PDCP packets from both transmission legs. The UE uses two RLC entities 515 and 516 to receive the two legs since the SNs of the data packets are allocated by different RLC entities 535 and 536 at network side. RLC SNs of the PTM leg is different from RLC SNs of the PTP leg for each subscriber UE. In one embodiment, the UE provides its independent uplink HARQ feedback to the network based on the reception of each transmission leg. There is no HARQ combination between the two legs. From RAN node side, the multicast data packets are duplicated over the PTM leg and the PTP leg at RLC layer.

In another embodiment 520, RLC SNs of the PTM leg and the PTP leg are aligned, and wherein the UE protocol stack includes one RLC entity that discards duplicated data packets. At the network side, the RLC SN allocation functionality of the PTM leg and PTP leg are combined together. RLC SNs of the PTM leg and the PTP leg for each subscriber UE are aligned. The RLC data packets delivered over PTM leg and PTP leg shares consistent RLC SN. Alternative UE 520 protocol stack includes a PHY entity 521, a MAC entity 523, a combined RLC entity 525 for duplicated data packets, and a PDCP entity 527. The UE uses a single RLC entity 525 to receive both PTM leg and PTP leg and discards the redundant RLC data packets based on the examination of the RLC SN of the data packets.

FIG. 6 illustrates exemplary diagrams for duplicated PDCP reception over the PTM and PTP legs. UE 610 is configured with an MBS. UE 610 is configured with a UE protocol stack for downlink (DL) data packets of the MBS with a PTM leg and a PTP leg. UE 610 protocol stack includes a PHY entity 611, a MAC entity 613, two RLC entities for duplicated data, a PTM RLC entity 615 and a PTP RLC entity 616, and a PDCP entity 617. UE 610 receives duplicated data packets for the MBS simultaneously from both the PTM leg and the PTP leg, processes the received duplicated data packets from the PTM leg and the PTP leg at a duplication protocol layer (e.g., the PDCP layer), wherein data packets for the MBS are duplicated at the PDCP layer at the network node. PDCP entity 617 sends the processed data packets 601 to upper layer of UE 610.

An exemplary network node, gNB 630, transmits one or more multicast flows 603 for an MBS to one or more UEs, such as UE 610. gNB 630 establishes a network protocol stack for downlink (DL) data packets of the MBS with PTM leg and the PTP leg. Data packets for the MBS are duplicated at a duplication protocol layer, the PDCP layer. The PDCP layer includes a PDCP SN allocation function entity 637, which allocates PDCP SN for both the PTM PDCP entity 638 and the PTP PDCP entity 639. The RLC layer includes a PTM RLC function entity 635 and a PTP RLC function entity 636. The network protocol stack also includes a PHY entity 631 and a MAC entity 633.

The multicast data packets are duplicated over the PTM leg and the PTP leg at the PDCP layer. The UE performs the PTP and PTM reception together. From the UE reception perspective, the UE uses two RLC entities to receive the data from PTM and PTP legs, which are RLC entity 615 for the PTM leg and RLC entity 616 for the PTP leg. There is a unified SN allocation 637 for the PDCP packets at the network side. The UE PDCP entity combines the packets received from the PTM leg and the PTP leg based on the unified PDCP SN. From RAN node side, the multicast data packets are duplicated over the PTM leg and the PTP leg at PDCP layer.

In another novel aspect, based on UE reception options, the UE reception option can be switched during MBS reception. In one embodiment, the decision to switch is made by the network. There are different cases for PTM/PTP switch from UE reception perspective. Each case needs different handling in order to enable service continuity during the PTM/PTP switch for the UE.

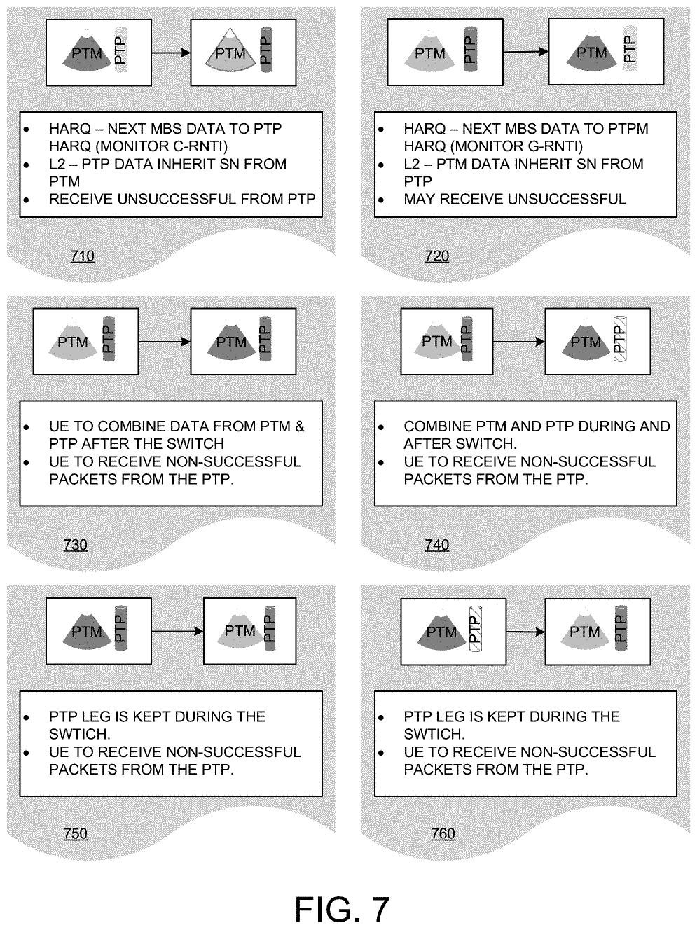

FIG. 7 illustrates exemplary diagrams of top-level procedures for different MBS mode switch procedures in MBS transmission and reception. As discussed in FIG. 3, there are four MBS delivery modes, the PTM-only 301, the PTP-only 302, the PTM-and-PTM 303 and the PTM-plus-retransmission-only-PTP mode 304. In one novel aspect, the network monitors one or more triggering event and initiates a mode switch. In the 1st scenario 710, the MBS delivery mode switches from PTM-only to PTP-only. During the switch, the data packets as delivered by the PTP leg needs to be consistent with the data packets as previously delivered by PTM leg, in order to ensure the service continuity. Specifically, if the PTM/PTP switch is implemented at HARQ, the next multicast TB from upper layer needs to deliver to PTP HARQ entity and the UE needs to monitor C-RNTI scrambled PDCCH for the PTP leg reception. If the PTM/PTP switch is implemented at L2, the next L2 packets transmitted to the UE via PTP leg needs to inherit the Sequence Numbering from PTM leg. In order to keep service continuity, the UE is expected to receive the non-successfully received data packets (from previous leg) after the switch from the new leg.

In the second scenario 720, the MBS delivery mode switches from PTP-only to PTM-only. During the switch, the data packets as delivered by the PTM leg needs to be consistent with the data packets as previously delivered by PTP leg, in order to ensure the service continuity. Specifically, if the PTM/PTP switch is implemented at HARQ, the next multicast TB from upper layer needs to deliver to PTM HARQ entity and the UE needs to monitor G-RNTI scrambled PDCCH for the PTM leg reception. If the PTM/PTP switch is implemented at L2, the next L2 packets transmitted to the UE via PTM leg may or may not match the SN from PTP leg. In order to keep service continuity, the UE may receive the non-successfully received data packets after the switch to the PTM leg.

In the third scenario 730, the MBS delivery mode switches from PTP-only to PTM-and-PTP mode. During the switch, the UE is required to combine the data packets from both PTM leg and PTP leg after the PTM/PTP switch. As the PTP leg is still kept, the case is in a better position to keep the service continuity, since the UE can receive the non-successfully received data packets after the switch from the PTP leg.

In the fourth scenario 740, the MBS delivery mode switches from PTP-only to PTM-plus-retransmission-only-PTP. During the switch, the UE is able to combine the data packets from both PTM leg and PTP leg (for retransmission) after the PTM/PTP switch. As the PTP leg is still kept for retransmission, the case is in a better position to keep the service continuity, since the UE can receive the non-successfully received data packets after the switch from the PTP leg. The data transmission consistency requirement is the same as 730.

In the fifth scenario 750, the MBS delivery mode switches from PTM-and-PTP to PTP-only. During the switch, the PTP leg is still kept, the case is in a better position to keep the service continuity, since the UE can receive the non-successfully received data packets after the switch from the PTP leg. The data transmission consistency requirement is the same as 710.

In the sixth scenario 760, the MBS delivery mode switches from PTM-plus-retransmission-only-PTP to PTP-only. During the switch, the PTP leg is still kept, and the UE can receive the non-successfully received data packets after the switch from the PTP leg. The data transmission consistency requirement is the same as 710.

In one embodiment, the MBS delivery mode switch is a dynamic switch determined by the network based on one or more predefined triggering event. In one embodiment, the dynamic mode switch is handled by HARQ. In another embodiment, the dynamic mode switch is handled by the RLC layer. In yet another embodiment, the dynamic mode switch is handled by the PDCP layer. In the first embodiment, the dynamic mode switch is handled by HARQ. For example, specific to scenario 710 based PTM-only to PTP-only switch, the UE specific PTP transmission leg can be established with a UE specific HARQ entity and the multicast TB is going to the PTP HARQ if there is no valid PTM transmission leg. In this case, the multicast TB is transmitted in a duplicated manner over multiple HARQ entity if multiple UEs receive their specific PTP leg (potentially including the PTM HARQ entity serving other UEs in PTM mode). When the UE did not correctly receive the previous multicast RB via PTM mode before the switch, there is a risk for the UE to miss this TB when switched to the PTP leg. The performance of the service continuity during dynamic switch is subject to the detailed HARQ operation, such as the HARQ feedback based HARQ retransmission, during the period, which can be coordinated with RAN1 for its further evaluation.

In a second embodiment, the dynamic mode switch is handled by the RLC layer. During the switch, the UE and the network uses the RLC layer-based uplink feedback. For example, specific to 710, the UE specific PTP transmission leg can be established as a RLC transmission leg. During the PTM-only to PTP-only switch, the PTM RLC functions at the RAN node can be simply disabled. The RLC SN allocation function delivers the new data packets to each UE specific RLC function established. From UE perspective, the protocol stack for data reception is kept but the monitoring on the PTM leg is not needed. The RAN node needs to notify this switch to the UE to perform such adaption from UE side. In one scenario, the multicast RB is kept at RAN node after the switch from the PTM-only to the PTP-only in order to continue supporting the PTM transmission to other UEs. For both the RAN node and the UE, the same PDCP entity is used after the switch. In another example of 760, the PTP leg existed for L2 based retransmission before the switch. After the switch, the PTP leg is used for initial transmission. If there is any RLC packets that is subject to retransmission after the switch, the data packets are transmitted over the PTP leg after the delivery mode switch.

In a third embodiment, the dynamic mode switch is handled by the PDCP layer. During the switch the UE and the network uses the PDCP layer-based uplink feedback. For example, specific to 710, the UE specific PTP transmission leg can be established as a PDCP transmission leg. During the switch, the PTM PDCP functions at the RAN node can be simply disabled. The common PDCP SN allocation function delivers the new data packets to each UE specific PDCP function established. From UE perspective, the protocol stack for data reception is kept but the monitoring on the PTM leg is not needed. For both the RAN node and the UE, the operation at PDCP is consistent after the mode switch since the PDCP SN allocation function is maintained. The PDCP feedback should be supported for PDCP-based mode switch in order to allow the PDCP-based retransmission after the mode switch.

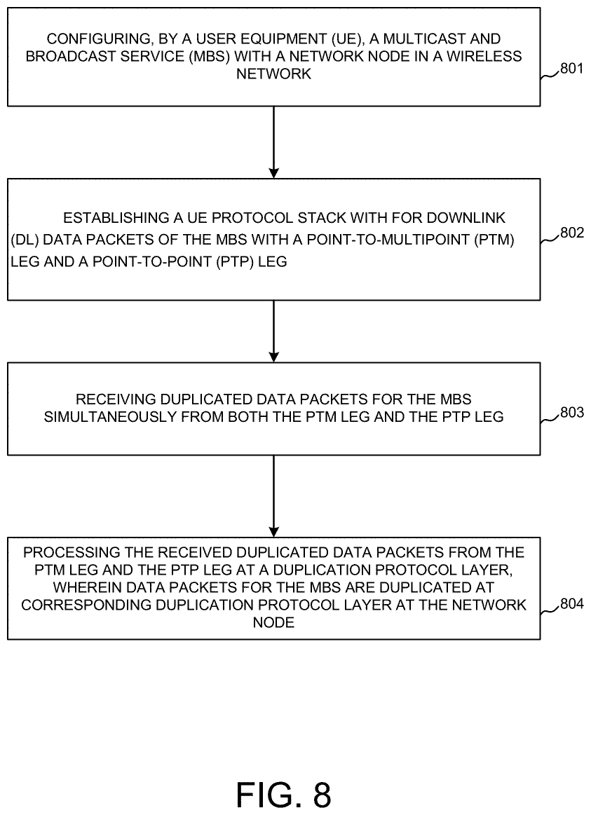

FIG. 8 illustrates an exemplary flow chart for the UE MBS reception with duplicated data packets. At step 801, the UE configures an MBS with a network node in a wireless network. At step 802, the UE establishes a UE protocol stack for downlink (DL) data packets of the MBS with a point-to-multipoint (PTM) leg and a point-to-point (PTP) leg. At step 803, the UE receives duplicated data packets for the MBS simultaneously from both the PTM leg and the PTP leg. At step 804, the UE processes the received duplicated data packets from the PTM leg and the PTP leg at a duplication protocol layer, wherein data packets for the MBS are duplicated at corresponding duplication protocol layer at the network node.

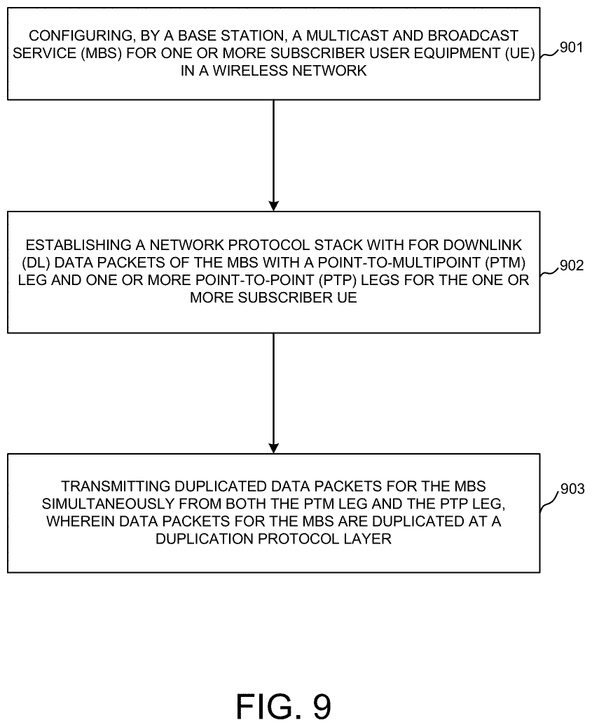

FIG. 9 illustrates an exemplary flow chart for the base station MBS transmission with duplicated data packets. At step 901, the base station configures an MBS for one or more subscriber user equipment (UE) in a wireless network. At step 902, the base station establishes a network protocol stack for downlink (DL) data packets of the MBS with a point-to-multipoint (PTM) leg and one or more point-to-point (PTP) legs for the one or more subscriber UE. At step 903, the base station transmits duplicated data packets for the MBS simultaneously from both the PTM leg and the PTP leg, wherein data packets for the MBS are duplicated at a duplication protocol layer.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
configuring, by a user equipment (UE), a multicast broadcast service (MBS) with a network node in a wireless network;
establishing a UE protocol stack for downlink (DL) data packets of the MBS with a point-to-multipoint (PTM) leg and a point-to-point (PTP) leg;
receiving duplicated data packets for the MBS simultaneously from both the PTM leg and the PTP leg; and
processing the received duplicated data packets from the PTM leg and the PTP leg at a duplication protocol layer, wherein data packets for the MBS are duplicated at corresponding duplication protocol layer at the network node.

2. The method of claim 1, wherein the duplication protocol layer is a packet data convergence protocol (PDCP) layer of the UE protocol stack, and wherein sequence numbers (SNs) for PDCP packets are unified at the PTM leg and the PTP leg.

3. The method of claim 2, wherein the UE protocol stack includes two radio link control (RLC) entities, one for the PTM leg and one for the PTP leg.

4. The method of claim 1, wherein the duplication protocol layer is an RLC layer of the UE protocol stack.

5. The method of claim 4, wherein RLC SNs of the PTM leg is different from RLC SNs of the PTP leg, and wherein the UE protocol stack includes two RLC entities one for the PTM leg and one for the PTP leg, and wherein a PDCP layer of the UE protocol stack discards duplicated data packets.

6. The method of claim 4, wherein RLC SNs of the PTM leg and the PTP leg are aligned, and wherein the UE protocol stack includes one RLC entity that discards duplicated data packets.

7. The method of claim 1, wherein the duplication protocol layer is a PHY layer of the UE protocol stack, and wherein the PTM leg and the PTP leg are both received at hybrid automatic repeat request (HARQ) layer.

8. The method of claim 7, wherein the UE monitors a group radio network temporary identifier (G-RNTI) for the PTM leg and a cell RNTI (C-RNTI) for the PTP leg.

9. The method of claim 1, wherein the processing of the received duplicated data packets includes at least one process comprising combining received data packets from the PTM leg and the PTP leg, and discarding duplicated data packets from the PTM leg and the PTP leg.

10. A method comprising:
configuring, by a base station, a multicast broadcast service (MBS) for one or more subscriber user equipment (UE) in a wireless network;
establishing a network protocol stack for downlink (DL) data packets of the MBS with a point-to-multipoint (PTM) leg and one or more point-to-point (PTP) legs for the one or more subscriber UE;
transmitting duplicated data packets for the MBS simultaneously from both the PTM leg and the PTP leg, wherein data packets for the MBS are duplicated at a duplication protocol layer.

11. The method of claim 10, wherein the duplicated protocol layer is a packet data convergence protocol (PDCP) layer of the network protocol stack, and wherein sequence numbers (SNs) for PDCP packets are unified at the PTM leg and the PTP leg.

12. The method of claim 10, wherein the duplication protocol layer is a radio link control (RLC) layer of the network protocol stack.

13. The method of claim 12, wherein RLC SNs of the PTM leg is different from RLC SNs of the PTP leg for each subscriber UE.

14. The method of claim 12, wherein RLC SNs of the PTM leg and the PTP leg for each subscriber UE are aligned.

15. The method of claim 10, wherein the duplication protocol layer is a PHY layer of the network protocol stack, and wherein data packets for the MBS are duplicated over the PTM leg and the PTP leg at hybrid automatic repeat request (HARQ) layer with different HARQ entities.

16. A user equipment (UE), comprising:
a transceiver that transmits and receives radio frequency (RF) signal in a new radio (NR) wireless network;
a multicast broadcast service (MBS) configuration module that configures an MBS with a network node in the wireless network;
a protocol module that establishes a UE protocol stack for downlink (DL) data packets of the MBS with a point-to-multipoint (PTM) leg and a point-to-point (PTP) leg;
an MBS reception module that receives duplicated data packets for the MBS simultaneously from both the PTM leg and the PTP leg; and
a duplication module that processes the received duplicated data packets from the PTM leg and the PTP leg at a duplication protocol layer, wherein data packets for the MBS are duplicated at corresponding duplication protocol layer at the network node.

17. The UE of claim 16, wherein the duplication protocol layer is a packet data convergence protocol (PDCP) layer of the UE protocol stack, and wherein sequence numbers (SNs) for PDCP packets are unified at the PTM leg and the PTP leg, and wherein the UE protocol stack includes two radio link control (RLC) entities, one for the PTM leg and one for the PTP leg.

18. The UE of claim 16, wherein the duplication protocol layer is an RLC layer of the UE protocol stack.

19. The UE of claim 18, wherein the UE protocol stack includes two RLC entities one for the PTM leg and one for the PTP leg when RLC SNs of the PTM leg is different from RLC SNs of the PTP leg, and wherein the UE protocol stack includes one RLC entity that discards duplicated data packets when RLC SNs of the PTM leg and the PTP leg are aligned.

20. The UE of claim 16, wherein the duplication protocol layer is a PHY layer of the UE protocol stack, and wherein the PTM leg and the PTP leg are both received hybrid automatic repeat request (HARQ) layer.
